(19) United States
(12) Patent Application Publication
(10) Pub. No.: US 2018/0088587 A1
(43) Pub. Date: Mar. 29, 2018

(54) Controlling Method and System for Autonomous Vehicle

(71) Applicants: Chunghsin Lee, Las Vegas, NV (US); Passion Mobility Ltd., Taipei City (TW)

(72) Inventor: Chunghsin Lee, Las Vegas, NV (US)

(21) Appl. No.: 15/279,495

(22) Filed: Sep. 29, 2016

(51) Int. Cl. G05D 1/02; G05D 1/00; G08G 1/13

(52) U.S. Cl. CPC G05D 1/0246; G05D 1/0088; G05D 1/0212; H04W 84/12; G05D 1/024; G05D 1/0238; G05D 1/0255; G08G 1/13

(57) ABSTRACT

A controlling method for an autonomous vehicle includes identifying a line track by the computing device via the camera set, and traveling the autonomous vehicle on a floor along the line track. When the autonomous vehicle is traveled relative to a wall, the line track is the wall-floor intersection, and the autonomous vehicle travels along the line track and parallel to the wall in a first predetermined distance determined by the computing device via the rangefinder and/or the camera set. When the autonomous vehicle travels where no walls are measured by the rangefinder and the camera set, the line track is a marking line on the floor, and the autonomous vehicle travels along the marking line in a second predetermined distance determined by the computing device via the camera set, and determining the travel path of the autonomous vehicle according to a preset map installed in the computing device.

### FIELD OF THE INVENTION

The present invention relates to a controlling method and system for an autonomous vehicle, and more particularly to a controlling method and system for controlling the traveling path using line tracking via a camera set and distance measurement via a rangefinder installed in the autonomous vehicle.

### BACKGROUND OF THE INVENTION

Autonomous vehicle technologies have advanced greatly in recent years. Many big Internet companies and most of the big car companies have allocated large resources to develop autonomous vehicle technologies to enable a driverless car to travel on public road at highway speed. Many navigation methods have been applied, in which most of them use global positioning system (GPS) combining a detailed local map to determine the track to travel.

However, GPS navigation system has its drawbacks. For instance, because of the high speed required, the vehicle employed many sophisticated sensors and powerful computers and complicated algorithm software to ensure the safety of the autonomous car and its surroundings. Furthermore, GPS related systems do not have enough resolution to navigate narrow roads and it does not work well for indoor applications or small and enclosed communities.

For these small and enclosed communities, such as vacation resorts or retirement communities, the speed required is generally low (less than 30 km/hr), and the surroundings are usually not complicated, autonomous vehicle is especially useful and making great economic sense if the infrastructure requirement is low.

To reduce the vehicle cost and infrastructure buildup, it is necessary to develop new navigation systems controlling the travelling path of an autonomous vehicle; a navigation method that does not require expensive sensors on the vehicles and requires very little infrastructure setup is strongly demanded. Additionally, for other methods such as those that follow tracks marked on the floor, it would be necessary to lay two tracks for both direction travels.

### SUMMARY OF THE INVENTION

An aspect of the present disclosure is to provide a controlling method for an autonomous vehicle having a computing device, a rangefinder connected to the computing device and configured for measuring the distance in a lateral direction, and a camera set connected to the computing device and capable of capturing a plurality of images along a travel path of the autonomous vehicle. The controlling method includes identifying a line track in the plurality of images by the computing device via the camera set, and traveling the autonomous vehicle on a floor along the line track. When the autonomous vehicle is traveled relative to a wall, the line track is where the wall meets the floor, and the autonomous vehicle travels along the line track and parallel to the wall in a first predetermined distance determined by the computing device via at least one of the rangefinder and the camera set. When the autonomous vehicle is traveled where no walls are measured by the rangefinder and the camera set, the line track is a marking line on the floor, and the autonomous vehicle travels along the marking line in a second predetermined distance determined by the computing device via the camera set, and determining the travel path of the autonomous vehicle in response to a preset map installed in the computing device.

According to an embodiment of the controlling method of the present invention, the aforementioned controlling method further includes determining the travel path of the autonomous vehicle when an obstacle in the travel path is identified in the plurality of images by the computing device via the camera set, and returning to the travel path once the obstacle is not detected by the computing device.

According to an embodiment of the controlling method of the present invention, the aforementioned controlling method further includes identifying an opposing vehicle approaching toward the autonomous vehicle in an opposite direction which the autonomous vehicle is travelling in by the computing device via the camera set, and changing the travel path of the autonomous vehicle by shortening the predetermined distance relative to the wall by the computing device.

According to an embodiment of the present invention, in which the rangefinder is an ultrasonic rangefinder, a laser rangefinder, or an optical rangefinder.

According to an embodiment of the controlling method of the present invention, in which the marking line is an adhesive tape, or a painted strip.

According to an embodiment of the controlling method of the present invention, in which the traveling velocity of the autonomous vehicle is less than 30 km/hr.

According to an embodiment of the controlling method of the present invention, in which the autonomous vehicle has at least two wheels.

According to an embodiment of the controlling method of the present invention, the aforementioned controlling method further includes positioning the autonomous vehicle in the preset map by a Wi-Fi positioning system relative to a plurality of access points.

According to an embodiment of the controlling method of the present invention, further includes positioning the autonomous vehicle in the preset map by a 3G or 4G positioning system relative to a plurality of mobile stations.

According to an embodiment of the controlling method of the present invention, in which the camera set includes at least two cameras disposed at a front side and a rear side of the autonomous vehicle, respectively.

According to an embodiment of the controlling method of the present invention, in which the field of view of each of the cameras of the camera set is at least 100 degrees.

According to an embodiment of the controlling method of the present invention, the aforementioned controlling method further includes recording a travel distance of the autonomous vehicle by the computing device, wherein the travel distance is measured by an odometer installed in the autonomous vehicle and connected to the computing device.

According to an embodiment of the controlling method of the present invention, the aforementioned controlling method further includes recording the travel direction of the autonomous vehicle by the computing device via a gyroscope or an accelerometer connected to the computing device.

According to an embodiment of the controlling method of the present invention, the aforementioned controlling method further includes calculating and recording the travel path of the autonomous vehicle by using the travel distance and the travel direction recorded in the computing device.

According to an embodiment of the controlling method of the present invention, in which determining the travel path of the autonomous vehicle in response to the preset map includes selecting a predetermined location in the preset map, and navigating the autonomous vehicle to the predetermined location by the computing device.

According to an embodiment of the controlling method of the present invention, the aforementioned controlling method further includes slowing down the autonomous vehicle when the travel speed thereof is greater than a predetermined speed by the computing device via an auto-breaking module connected to the computing device.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a functional block diagram illustrating a controlling system of an autonomous vehicle according to an embodiment of the present invention;

FIG. 2 is a schematic diagram illustrating an autonomous vehicle traveling on a floor according to an embodiment of the present invention;

FIG. 3 is a flow chart illustrating a controlling method of an autonomous vehicle according to an embodiment of the present invention;

FIG. 4 is a schematic diagram illustrating an obstacle blocking in the travel path of an autonomous vehicle according to an embodiment of the present invention;

FIG. 5 is a flow chart illustrating a method of avoiding the obstacle shown in FIG. 4 according to an embodiment of the present invention;

Fig.6 is a schematic diagram illustrating an environment for two-way traffic of an autonomous vehicle according to an embodiment of the present invention; and

FIG. 7 is a flow chart illustrating a method while facing opposing vehicle shown in FIG. 6 according to an embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method or the system by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items. It will be understood that when an element is referred to as being “connected” to another element, it can be directly connected to the other element or intervening elements may be present. In contrast, when an element is referred to as being “directly connected” to another element, there are no intervening elements present.

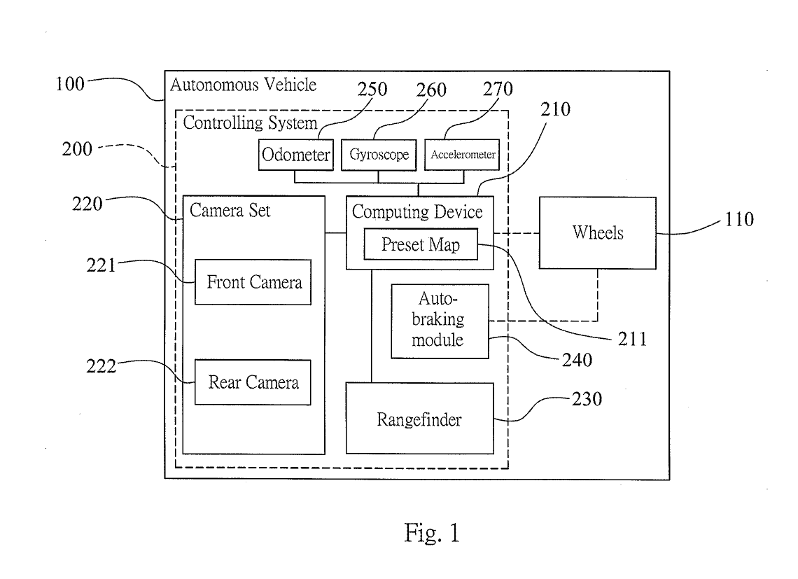

FIG. 1 is a functional block diagram illustrating a controlling system 200 of an autonomous vehicle 100 according to an embodiment of the present invention. The autonomous vehicle 100 has at least two wheels 110, and the controlling system 200 is installed in the autonomous vehicle 100. The controlling system 200 includes a computing device 210, a rangefinder 230, a camera set 220, and an auto-breaking module 240. The turning of the wheels 110 are determined and controlled by the computing device 210, in which the computing device 210 has a preset map 211 installed in the computing device 210. The preset map 211 may be a local map where the autonomous vehicle 100 travels in, where the local map may have numerous pre-set interest points showing on it. The rangefinder 230 is capable of measuring lateral distance between the autonomous vehicle 100 and an object parallel to the traveling direction of the autonomous vehicle 100. In some embodiments, the rangefinder 230 measures the lateral distance between the autonomous vehicle 100 and a wall 400, and may determine whether the wall 400 exists or not. The rangefinder 230 can be an ultrasonic rangefinder, an optical rangefinder, an infrared rangefmder operating with or without a retroreflector disposed on the wall 400, or a laser rangefinder. Taking the infrared rangefinder as an example, lights emitted from the infrared rangefinder may be reflected by the wall 400 back to the infrared rangefinder for measuring the distance traveled, thereby calculating the distance between the infrared rangefinder and the wall 400. Optionally, retroreflectors may be disposed on the wall 400 such that the lights emitted from the infrared rangefinder may be bounced back even if the wall 400 is made of material that is not capable of reflecting back the lights, or the distance between the infrared rangefinder and the wall 400 is too far for reflecting back the lights. The rangefinder 230 is connected to the computing device 210. The rangefinder 230 transmits data of those lateral distances to the computing device 210. In practice, the rangefinder 230 may be plural and can be installed at where the walls or other objects of interest are to be detected and measured. The camera set 220 includes a front camera 221 and a rear camera 222, in which the front camera 221 is installed at a front side of the autonomous vehicle 100, and the rear camera 222 is installed at the rear side of the autonomous vehicle 100. The front camera 221 and the rear camera 222 may be installed around the front and rear license plates respectively. The camera set 220 is used to capture dynamic images while the autonomous vehicle 100 travels along a travel path with an image-capturing rate of, for instance, 60 fps to 240 fps.

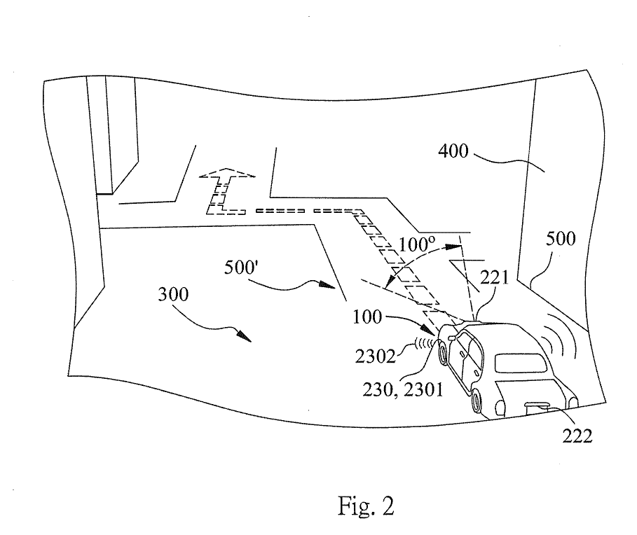

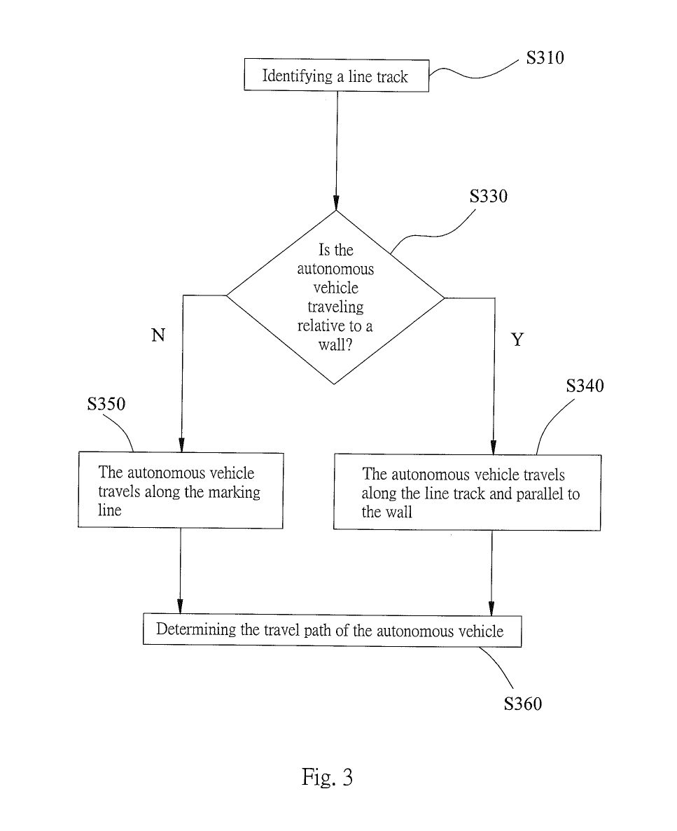

Referring to FIG. 2 and FIG. 3, where FIG. 2 is a schematic diagram illustrating the autonomous vehicle 100 traveling on a floor 300 according to an embodiment of the present invention, and FIG. 3 is a flow chart illustrating a controlling method of an autonomous vehicle 100 using the controlling system 200 according to an embodiment of the present invention. While the autonomous vehicle 100 travels on the floor 300, the front camera 221 of the camera set 220 captures numerous images and the computing device 210 processes the images and identifies line tracks 500/500′ which the autonomous vehicle 100 follows along.

The environment where the autonomous vehicle 100 travels in may or may not have a wall 400 detected by the camera set 220 and/or the rangefinder 230 and determined by the computing device 210. For instance, the rangefinder 230 may be an ultrasonic rangefinder, which emits ultrasonic waves laterally and receives the reflected ultrasonic waves to determine the lateral distance between the autonomous vehicle 100 and the wall 400 reflecting the ultrasonic waves. When there is no walls along the traveling path of the autonomous vehicle 100, there would be no reflected ultrasonic waves received by the ultrasonic rangefinder 230, which means that the object to be measured is out of range; the computing device 210 would then determine that there is no walls in the environment via the rangefinder 230. It can be also determined by applying image processing technologies with the camera set 220. For example, a wall-line intersection, the line track 500, may be formed when the wall 400 exists that meets with the floor 300, which can be identified by the computing device 210 via the camera set 220. Further, when no wall-line intersections are detected, the computing device 210 would determine that no walls exist in the current environment that the autonomous vehicle is traveling in.

Referring to FIG. 3, in step S310, when the computing device 210 detects the wall 400 via the camera set 220 and/or the rangefinder 230, the computing device 210 identifies the line track 500. In step S330, the computing device 210 determines whether the wall 400 exists. When the wall 400 exists, in step S340, the autonomous vehicle 100 is traveled parallel to the line track 500 formed between the wall 400 and the floor 300 and in a first predetermined distance from the wall 400 determined by the computing device 210. The aforesaid first predetermined distance may be set manually into the computing device 210 by a user prior to the autonomous vehicle 100 has been started to travel. The first predetermined distance may range between 10 centimeters to 2 meters.

If the wall 400 does not exist, that is, when both the camera set 220 and the rangefinder 230 have detected no walls, step S350 would be triggered following step S330. The computing device 210 would start to search for the line track 500′ on the floor 300, where the line track 500′ may be a marking line, painted strip, magnetic tape, colored tape or any other line-shape means marked on the floor 300. The autonomous vehicle 100 will then be traveled along the line track 500′ in a second predetermined distance determined by the computing device 210 via the camera set 220.

In step S360, the travel path of the autonomous vehicle 100 can be determined by selecting one of the pre-set interest point in the preset map 211. The pre-set interest point may be manually selected by a user when entering the autonomous vehicle 100 on the preset map 211. The autonomous vehicle 100 may have a display (not shown) disposed inside showing the preset map 211 with the pre-set interest points, the pre-set interest points may be shown as pins or icons on the display, and the user may select one as a destination to travel to, and the computing device 210 will calculate a navigation path for traveling the autonomous vehicle 100. The computing device 210 calculates where to make a turn after a distance traveled.

A radar sensor or another rangefinder (not shown) may be installed at the front side of the autonomous vehicle 100, which is also connected with the computing device 100 as well and working together with the camera set 220, to detect a moving object like a passing pedestrian in order to avoid collision. This process is performed by initiating the auto-breaking module 240 by the computing device 210 while the computing device 210 detects a moving pedestrian passing in front of the autonomous vehicle 100 via the radar or the other rangefinder. Once the moving pedestrian has been detected, a signal indicating the moving pedestrian will be transmitted from the radar sensor or the other rangefinder to the computing device 210 to break the wheels 110.

Preferably, the autonomous vehicle 100 may contain a gyroscope or an accelerometer (not shown) connected to the computing device 210, to measure the orientation of the autonomous vehicle 100 while it travels. The data measured by the gyroscope or accelerometer may be stored in the computing device 210. What is more, the autonomous vehicle 100 may have an odometer (not shown) installed, indicating the distance traveled. The odometer is connected to the computing device 210, and the travel distance data measured will be transmitted to the computing device 210 as the autonomous vehicle 100 advances. The orientation and travel distance data transmitted to and stored in the computing device 210 are used to make a backup of the traveling path of the autonomous vehicle 100. Those data may also be used as a purpose of facilitating the investigation of car accidents.

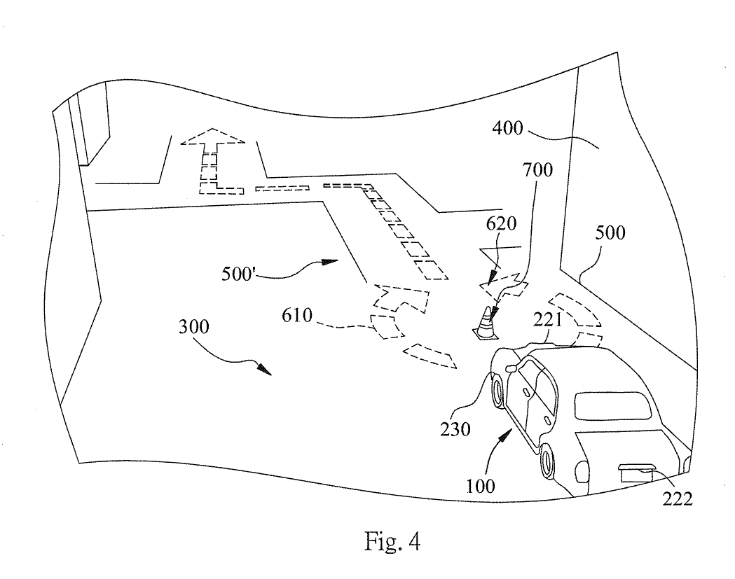

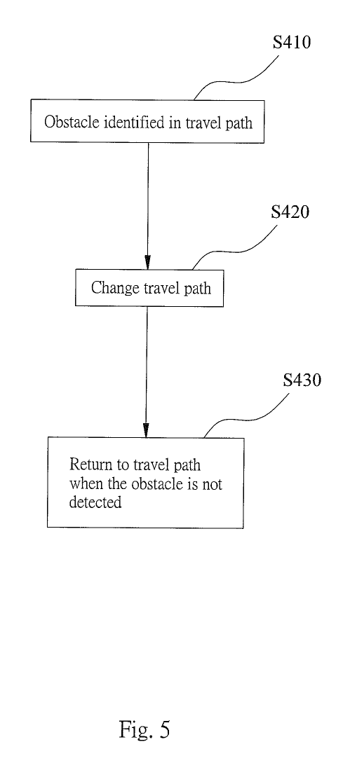

Referring to FIG. 4 and FIG. 5. FIG. 4 is a schematic diagram illustrating an obstacle blocking in the travel path of an autonomous vehicle according to an embodiment of the present invention, and FIG. 5 is a flow chart illustrating a method for avoiding the obstacle shown in FIG. 4 according to an embodiment of the present invention. In reality, various static obstacles might be appearing on the floor 300 blocking in the traveling path of the autonomous vehicle 100 such as a traffic cone, an animal body, a hurdle and the like; for instance, referring to FIG. 4 and step S410 in FIG. 5, the computing device 210 may detect and identify an obstacle 700 lying on the floor 300 blocking in front of the autonomous vehicle 100 via the camera set 220. The camera set 220 captures images having the obstacle 700 showing on, and the computing device 210 analyzes the images via image processing means and determines whether the obstacle 700 is blocking in the way or not. If the obstacle 700 is blocking in the way where the autonomous vehicle 100 is traveling in, step S420 will be triggered, in which the computing device 210 transmits a bypass signal to the wheels 110 in order to change the moving direction of the autonomous vehicle 100 for changing the traveling path of the autonomous vehicle 100. The computing device 210 can choose either to bypass the obstacle from the left side 610 or the right side 620 according to the current environment. For instance, when both the left and right walls 400 exist at the moment the autonomous vehicle 100 meets the obstacle, either the camera set 220 or the rangefinder 230 measures the distances between the autonomous vehicle 100 and the walls 400 and transmits the data to the computing device 210. Then, the computing device 210 calculates and determines whether to bypass the obstacle 700 from the left side 610 or the right side 620; when the distance between the autonomous vehicle 100 and the wall 400 located on the right side 620 is shorter than the distance between the autonomous vehicle 100 and the wall 400 located on the left side 610, then the computing device 210 determines to bypass the obstacle from the left side 610, and vice versa.

Further, when there is no wall at the moment the autonomous vehicle 100 meets the obstacle 700, the autonomous vehicle 100 bypasses the obstacle 700 randomly from the left side 610 or the right side 620 as determined by the computing device 210. In step S430, once the obstacle 700 has been bypassed, the autonomous vehicle 100 will be returned to the original travel path as determined by the computing device 210 prior to the obstacle being met.

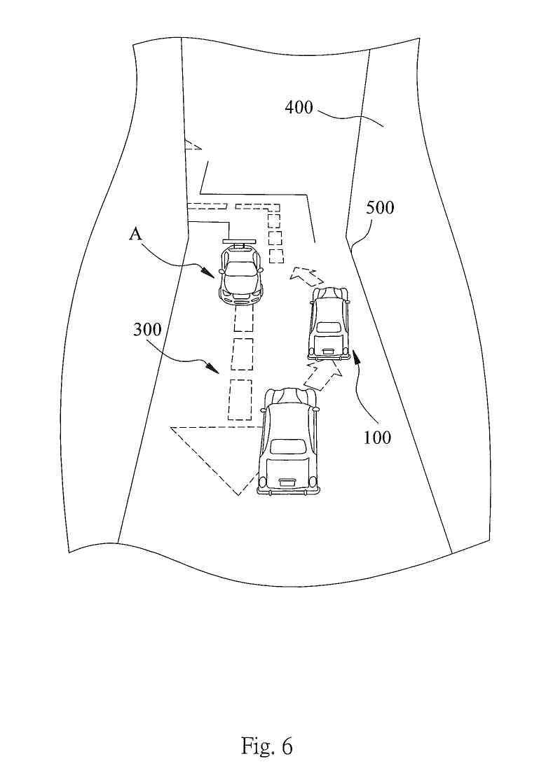

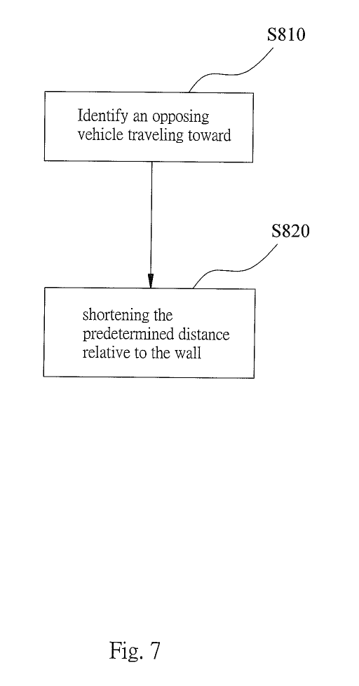

In some embodiments, the controlling method of the present invention is also applicable to two-way traffic. Practically, vehicles opposing the traveling path of the autonomous vehicle 100 may occur, and the controlling method of the present invention is capable of overcoming this issue. Referring to FIG. 6 to FIG. 7, where FIG. 6 is a schematic diagram illustrating an environment for two-way traffic of the autonomous vehicle 100 according to an embodiment of the present invention and FIG. 7 is a flow chart illustrating the steps of a method for bypassing an opposing vehicle A shown in FIG. 6 according to an embodiment of the present invention. While the opposing vehicle A comes toward the autonomous vehicle 100 in an opposite direction of which the autonomous vehicle 100 is traveling in, the computing device 210 detects and identifies the existence of the opposing vehicle A via the camera set 220 (see step S810). Then, in step S820, the computing device 210 gradually shortens the distance of the autonomous vehicle 100 to the wall 400 located at one side of the autonomous vehicle 100, in order to let the opposing vehicle A pass by. The controlling method for an autonomous vehicle of the present invention has following advantages:

Firstly, by keeping a fix distance from a wall by cameras and rangefinder operating with computing device along a line track formed between wall and floor, and switching to another traveling mode as to travel along marking lines on floor while no walls are detected, this method is perfectly applicable for both indoor and outdoor applications.

Secondly, two-way traffic can be easily achieved by applying the controlling method of the present invention to an autonomous vehicle while facing opposing vehicles.

Thirdly, no central station or server for the system is needed, because all traveling paths are determined by the computing device installed in the autonomous vehicle.

Finally, any kind of line will work as the lines, i.e. line tracks, will be automatically identified by the computing device via the camera set. Besides, for indoor use, ultrasound signal can help with more precise distance measurement while working together with the camera set, and can also be as a backup once the camera set has malfunctioned.

The description of the invention including its applications and advantages as set forth herein is illustrative and is not intended to limit the scope of the invention, which is set forth in the claims. Variations and modifications of the embodiments disclosed herein are possible, and practical alternatives to and equivalents of the various elements of the embodiments would be understood to those of ordinary skill in the art upon study of this patent document. For example, specific values given herein are illustrative unless identified as being otherwise, and may be varied as a matter of design consideration. Terms such as “first’ and “second” are distinguishing terms and are not to be construed to imply an order or a specific part of the whole. These and other variations and modifications of the embodiments disclosed herein, including of the alternatives and equivalents of the various elements of the embodiments, may be made without departing from the scope and spirit of the invention, including the invention as set forth in the following claims.

1. A controlling method comprising:
providing an autonomous vehicle having a computing device, an an ultrasonic rangefinder connected to the computing device and measuring a distance in a lateral direction, and a camera set connected to the computing device and capturing a plurality of images along a travel path of the autonomous vehicle;
identifying a line track in the plurality of images by the computing device via the camera set;
traveling the autonomous vehicle on a floor along the line track, wherein when the autonomous vehicle is traveled relative to a wall, the line track is where the wall meets the floor, and traveling the autonomous vehicle along the line track and parallel to the wall in a first predetermined distance determined by the computing device via the ultrasonic rangefinder and the camera set;
emitting ultrasonic waves laterally and receiving the reflected ultrasonic waves by the ultrasonic rangefinder and determining a lateral distance between the autonomous vehicle and the wall reflecting the ultrasonic waves;
determining the travel path of the autonomous vehicle in response to a preset map installed in the computing device; and
identifying an opposing vehicle approaching toward the autonomous vehicle in an opposite direction which the autonomous vehicle is travelling by the computing device via the camera set, and changing the travel path of the autonomous vehicle by shortening the lateral distance relative to the wall by the computing device.

2. The controlling method as claimed in claim 1, further comprising changing the travel path of the autonomous vehicle when an obstacle in the travel path is identified in the plurality of images by the computing device via the camera set, and returning to the travel path once the obstacle is not detected by the computing device.

3-6. (canceled)

7. The controlling method as claimed in claim 1, wherein the autonomous vehicle has at least two wheels.

8-9. (canceled)

10. The controlling method as claimed in claim 1, wherein the camera set includes two cameras disposed at a front side and a rear side of the autonomous vehicle, respectively.

11. The controlling method as claimed in claim 10, wherein the field of view of each of the two cameras of the camera set is at least 100 degrees.

12. The controlling method as claimed in claim 1, further comprising recording a travel distance of the autonomous vehicle by the computing device, wherein the travel distance is measured by an odometer installed in the autonomous vehicle and connected to the computing device.

13. The controlling method as claimed in claim 12, further comprising recording a travel direction of the autonomous vehicle by the computing device via a gyroscope or an accelerometer connected to the computing device.

14. The controlling method as claimed in claim 13, further comprising calculating and recording the travel path of the autonomous vehicle by using the travel distance and the travel direction recorded in the computing device.

15. The controlling method as claimed in claim 1, wherein determining the travel path of the autonomous vehicle in response to the preset map includes selecting a predetermined location in the preset map, and navigating the autonomous vehicle to the predetermined location by the computing device.

16. A controlling system of an autonomous vehicle having at least two wheels, comprising:
a computing device controlling the at least two wheels and having a preset map installed therein;
an ultrasonic rangefinder connected to the computing device and measuring distance in a lateral direction; and
a camera set connected to the computing device capturing a plurality of images along a travel path of the autonomous vehicle;
wherein the computing device is configured to identify a line track in the plurality of images by the computing device via the camera set, wherein the autonomous vehicle travels on a floor along the line track, wherein when the autonomous vehicle travels relative to a wall, the line track is where the wall meets the floor and the autonomous vehicle travels along the line track and parallel to the wall in a predetermined distance determined by the computing device via the ultrasonic rangefinder, wherein the ultrasonic rangefinder is configured to emit ultrasonic waves laterally and receive reflected ultrasonic waves to determine lateral distance between the autonomous vehicle and the wall reflecting the ultrasonic waves; wherein the computing device is configured to change the travel path of the autonomous vehicle in response to the preset map, wherein the computing device is configured to identify an opposing vehicle approaching toward the autonomous vehicle in an opposite direction which the autonomous vehicle is travelling via the camera set, and change the travel path of the autonomous vehicle by shortening the predetermined distance relative to the wall.

17-18. (canceled)
